(19) United States
(12) Patent Application Publication
(10) Pub. No.: US 2011/0215076 A1
(43) Pub. Date: Sep. 8, 2011

(54) LASER ABLATION TECHNIQUE

(75) Inventors: Gareth Littlewood, Manchester (GB); Zhu Liu, Manchester (GB); Lin Li, Manchester (GB); Charles Malcolm Ward-Close, Alton (GB)

(73) Assignee: QINETIQ LIMITED, Farnborough, Hampshire (GB)

(21) Appl. No.: 13/128,334

(22) PCT Filed: Sep. 28, 2009
(86) PCT No.: PCT/GB2009/002312

§ 371 Date: May 9, 2011

(30) Foreign Application Priority Data
Nov. 13, 2008 (GB) 0820731.8
Feb. 12, 2009 (GB) 0902337.5

(51) Int. Cl. B23K 26/00

(52) U.S. Cl. 219/121.85

(57) ABSTRACT

A method of manufacturing a shaped part, the method including: (I) providing a partially consolidated porous part that has been made from a powder; (II) permeating the porous part with a volatile liquid (e.g. water, ethanol), so that the liquid is present in the pores of the porous part; and (V) forming the shaped part by applying a laser beam to a spot on the surface of the liquid-permeated part to cause the volatile liquid to heat in the spot region, causing the powder particles to separate in the spot region, so that a portion of the part is ablated in the spot region. The porous part may be made from metallic or ceramic powder and has been partially consolidated for integrity, but is ablated by this lower energy, liquid-assisted laser process, prior to further strengthening. The method allows bespoke, complex shaped parts such as aerospace parts or medical implants to be made inexpensively, especially shaped titanium parts.

This invention relates to a method of manufacturing shaped parts by a laser ablation technique, and to parts so formed. It is especially suitable for manufacturing one-off parts of complex shapes, especially metallic or ceramic parts, e.g. titanium parts. It especially relates to manufacturing shaped parts from powders.

The laser has been widely accepted as a tool for rapid prototyping and manufacturing of small, low production volume powder-compacted parts, for example sintered parts. The processes used are broadly categorised into those in which material is added to the path of the laser beam, building new material onto the substrate (additive processes) and those which remove material via laser induced melting or vaporisation from a pre-formed workpiece (subtractive processes).

Both additive and subtractive techniques have been used for manufacture of complex geometry components, but particularly where higher processing speeds, enhanced mechanical properties and/or enhanced surface finishes are desired subtractive processes involving the precise removal of material from a workpiece have been investigated. Subtractive techniques are generally referred to as “laser milling”.

The paper “Laser Milling” by Pharm et al in Proceedings of the Institute of Mechanical Engineers, Volume 216 Part B, pages 657-667, 2002, describes the basis of the known laser milling technique. Typically laser radiation is delivered to a workpiece in an ordered sequence of pulses with a predetermined pulse length (duration) and repetition rate (frequency). This allows the accumulated energy to be released in very short time intervals, resulting in extremely high peak power. It also explains that additionally the laser beam can be focused on a small spot (10-50 μm) which leads to a significant energy density (fluence) and intensity (power density) in the spot area. As a result an extremely high power density (10¹⁷-10²² W/m²)) can be released in the laser/material interaction zone resulting in very high spot temperatures. A mechanism of laser ablation described in the paper is that the high temperature at the laser/workpiece interface creates solid plasma, a substance consisting of loosely bound ions and electrons on the material surface, the solid plasma leaving the material after the end of the pulse, expanding in a highly ionized state. It is noted that the laser ablation occurs only at wavelength for which the particular material is strongly absorptive, hence for optimal machining results a proper match of laser source and material should be achieved.

Generally, the higher the absorption by the material of the workpiece, the more effective the laser milling process. It is also noted that low thermal conductivity materials such as ceramics can easily be machined by laser milling since the absorbed energy is dissipated slowly to the bulk of the material. This paper also describes how laser ablation efficiency can be increased by performing the process at elevated temperatures under water.

“Laser Milling—A practical Industrial solution for machining a wide variety of materials” by Henry et al, Fifth international Symposium on Laser Precision Microfabrication, 2004 pages 627-631 notes that there are a wide range of laser sources available ranging from far infrared to deep ultra violet, and also a range of suitable pulse durations from continuous wave to femtosecond pulses. It also notes that the laser wavelength affects the size of the spot that the laser beam can be focussed down to, the shorter the wavelength the smaller the achievable spot size. This spot has to be small enough that the desired feature size can be achieved during laser milling.

The known process of laser milling may damage heat sensitive materials, for example titanium, since the surface temperatures are high, and the removal rates achieved using laser milling processes are typically slow. For example the above mentioned paper “Laser Milling—A practical Industrial solution for machining a wide variety of materials” by Henry et al describes removal rates of about 4 mm³/minute for an Nd:YAG laser on steel.

U.S. Pat. No. 5,932,10 describes a method of laser shock peening a titanium gas turbine engine by firing a stationary laser beam with a low power laser beam, having an energy output in a range of about 3-10 Joules, to vaporise material on the surface. The purpose of the laser shock peening is to produce laser shock peened regions having localized compressive residual stresses. The low power laser beam results in a surface laser energy density of approximately 100-400 J/cm². Laser spot beams of 1 mm are used. A curtain of water is passed over the surface upon which the laser beam is firing. Ablated paint material is washed out by the curtain of flowing water.

DE 19501279 notes in its own prior art section that it is known to use pulsed UV laser radiation for material removal, but states that the problem with this is that only low erosion rates are achieved. This is thought to be because of material melting back on. The solution provided by the reference is to cover the surface of the material, before and/or during the impact of the laser pulses, with a liquid film so that the problem of the deposits and the melting-on is eliminated.

DE 10303063 describes a method wherein a laser beam is directed onto a metal surface to cause a heat increase and turn the metal into plasma, so that the vaporized plasma material can be cleared away. The material is covered with fluid to limit expansion of the plasma material. The publication states that a known problem with prior art laser ablation techniques is that, particularly at the edge regions of the ablated regions, the material may re-deposit itself. The fluid covering restrains an expansion of the plasma material, generating a shock wave towards the material body which tends to accelerate material erosion, and also removes any undesirable material deposits in the edge regions.

“Underwater and water-assisted laser processing” Optics and Lasers in Engineering 41 (2004) 307-327 describes the use of water assisted lasers to clean the surfaces of workpieces. In this method a liquid film (usually water) on the surface is superheated by a short laser pulse (absorbed in the substrate or the liquid) and subsequently explosively evaporated. The expanding vapour ejects the dirt particles at the surface.

A first aspect of the present invention provides a method of manufacturing a shaped part, the method comprising:

(I) providing a partially consolidated, porous part that has been made from a powder;

(II) permeating the porous part with a volatile liquid, so that the liquid is present in the pores of the porous part; and

(III) forming the shaped part by applying a laser beam to a spot on the surface of the liquid-permeated part to cause the volatile liquid to heat in the spot region, causing the powder particles to separate in the spot region, so that a portion of the part is ablated in the spot region.

Such a liquid-assisted laser ablation process allows a porous part to be shaped using lower laser energies and will typically be conducted as an intermediate step upon a porous part that has been partially consolidated or densified (e.g. a green part) but which subsequently requires further densification to reach the final product density.

Preferably the method according to the first aspect of the invention provides the step of partially consolidating a powder to make the porous part provided in step (I) of the method.

Preferably the method according to the first aspect of the invention also comprises the step of strengthening the laser-ablated part.

In the method according to the first aspect of the invention the powder preferably comprises a metallic or ceramic material.

A second aspect of the present invention provides a method of manufacturing a shaped metallic or ceramic part, the method comprising:
(I) partially consolidating a powder of a metallic or ceramic material to make a porous green part;
(II) permeating the green part with a volatile liquid, so that the liquid is present in the pores of the porous green part;
(III) scanning a laser beam over a spot on the surface of the liquid-permeated green part to cause the volatile liquid to heat in the spot region, causing the partially consolidated powder particles to separate in the spot region, so that a portion of the part is ablated in the spot region; and
(IV) further strengthening the green part to form the shaped metallic or ceramic part.

When we say that a portion of the part is ablated in the spot region we mean that any bonds connecting that portion of the part to adjacent regions of the part are broken so that the part is removed, indeed, in some cases physically ejected from the part, or we mean that any bonds connecting that portion of the part to adjacent regions of the part are at least significantly weakened so that the portion of the part can be easily removed by applying an external force on the scanned region such as by brushing the region or blowing air or other fluid onto the region or by any other simple physical removal technique.

The term “green part” as used herein means any partially consolidated, one-piece part that still needs some further consolidation. It may be a regular shaped block or more usually a pre-cursor shaped part.

The porous part according to the invention may be a pre-cursor shaped part. The formed shaped part according to the invention is preferably close to, or at its final desired shape, and is preferably a near net shape, as defined hereinafter, requiring little or no finishing processes.

As used in this patent specification, the term “volatile” liquid means a liquid that can be vaporised by the application of the laser beam. Typically the volatile liquid will be one that will vaporize when heated to temperatures in the range 75-150° C., and for some embodiments the volatile liquid is preferably one that will vaporize when heated to a temperature of at least 100° C. A suitable and convenient volatile liquid for use in the present invention is water. While water is the most common, safe and cheap medium, other suitable non-reactive volatile liquids could be selected by the skilled person, particularly where an aqueous environment is not desirable. One example of a volatile liquid other than water that may be used is ethanol. Where water or any other volatile liquid is used, additives may be added to the liquid, e.g. wetting agents.

The step of applying a laser beam to a spot on the surface of the liquid permeated, partially consolidated, porous part may be carried out by scanning a laser beam over a spot on the surface of the part. This may be achieved by moving the laser itself, or by moving the part under a stationary laser beam, or by a combination of movement of the laser and the part. The laser may be programmed to follow a computer aided design (CAD) and may remove material in a layer-by-layer fashion.

The steps according to the methods of the first and second aspect of the invention are preferably carried out sequentially as listed, though it is envisaged that some steps could be carried out contemporaneously. For example, the liquid permeation step and laser application or scanning step could be carried out contemporaneously.

The methods of the invention may be used on any suitable porous part that has been partially consolidated from a powder, or starting from the powder itself. The starting powder in the method according to the second aspect of the invention, or the powder that has been partially consolidated to make the provided porous part in the method according to the first aspect of the invention, may comprise any suitable material that can be partially consolidated to form a porous part, and preferably then further consolidated. The powder preferably comprises a metallic and/or ceramic material, and preferably consists essentially of a metallic and/or ceramic material, and may be selected, for example, from a metal, an alloy, an intermetallic compound, a ceramic material, a blended elemental (BE) material or a cermet. As examples of suitable materials that could be used there may be mentioned most metals and alloys, for example titanium, precious metals, aluminium, iron based alloys such as steels, copper based alloys, intermetallic compounds such as titanium aluminide, ceramics such as oxides, carbides, nitrides and borides, for example steatite (Mg0SiO2) and alumina (Al2O3). Suitable materials are those that do not dissolve or disintegrate when the volatile liquid is absorbed by the partially consolidated part.

The partial consolidation step, carried out in preferred embodiments of the method according to the first aspect of the invention, and carried out in step I of the method according to the second aspect of the invention, may comprise partially sintering the material. Sintering is a method for making objects from powder, by heating the material below its melting point until its particles adhere to each other. Sintering is well known for use in manufacturing ceramic objects, and parts from powdered metals. As alternatives to sintering there may be mentioned die pressing, or cold isostatic pressing (where a rubber mould in a liquid filled pressure vessel is used) or any other suitable pre-consolidation method. Pressing processes such as CIPing are typically faster than sintering, but generally are most suitable for forming articles from shaped or irregular powder particles. Also it has been found that, at least for certain powders and certain volatile liquids, sintering may provide a consolidated part that is better able, or more quickly able, to absorb the volatile liquid. For any given powder and volatile liquid combination the choice of suitable consolidation technique to give the required porosity in the partially consolidated part, and hence the desired response to the subsequent laser ablation, could be ascertained by the skilled man by experimentation and/or modelling.

The consolidation methods advantageously produce a porous powder “compact” with the desired strength (sometimes known as “green strength”) in which individual powder particles are only lightly bonded together.

The partial consolidation step, where included in a multi-stage process, is carried out such that the partially consolidated part is strong enough to be handled before and after the application of the laser beam in step III without damage, but remains sufficiently porous with weak bonds between particles which can be relatively easily broken during laser processing and so allow material removal. If too little consolidation is done in the partial consolidation step the part can not be handled without damage, and if too much consolidation is done in the partial consolidation step the powder particles will be too tightly bound to each other to be easily removed during the laser application step.

In one embodiment, the partially consolidated part is preferably sufficiently porous that there is a continuous path connecting pores throughout the material, i.e. the pores are interconnected (open-celled). The pores may be uniformly distributed throughout the material, or non-uniformly distributed. Similarly the pore sizes may be substantially the same size or may be of a range of different sizes. As an example a range of pore sizes from 1 to 100 μm may be used. In some embodiments a range of pore sizes in the range 10-20μm is used. Typically, the volume fraction of the partially consolidated part that is occupied by the pores is in the range 0.05 to 0.8, or 0.15 to 0.8, or for some embodiments in the range 0.05 to 0.6. This typical volume fraction is the same regardless of material type of the powder. If the volume fraction of pores is <0.05 then the pores become isolated, which is undesirable. For some embodiments according to the invention the volume fraction of the partially compacted part that is occupied by the pores is in the range 0.35 to 0.45.

Factors which affect the achievement of the desired porosity and strength of the partially consolidated part include (a) the initial powder particle size, (b) the particle shape (e.g. whether the particles are substantially spherical as might result, for example, by manufacture by an atomisation process for say titanium, or whether the particles are irregular, as might result, for example, by manufacture by a hydride de-hydride process for say titanium), (c) whether similar size particles are used in the powder or a range of sizes (a range of sizes typically giving a denser part since smaller particles fit within interstices between larger particles), and (d) any heating cycle conditions manufacturing the porous part, e.g. during an initial partial consolidation process step. For example, sintering may advantageously be used as a partial consolidation step for regular, substantially spherical powder particles, and a pressing technique such as cold isostatic pressing (CIPing) might advantageously be used for partial consolidation of irregular shaped particles. These factors will, inter alia, affect not only the initial porosity of the porous part, but also the amount of densification resulting from any partial consolidation step, and hence, in those cases, the post-partial-consolidation porosity. Tailoring these factors to achieve the desired porosity and strength would be a matter of simple trial and error for the man skilled in the art. Where partial sintering or any other process involving heat is used in a partial consolidation step, partially to consolidate the powder part, then the sintering or other heating temperature used is preferably about 0.8× melting point in Kelvin of the powder. In certain embodiments of the invention sintering is used as a partial consolidation technique for metal powders, and CIPing is used as a partial consolidation technique for ceramics, in order to make the porous part. The same process may also be used for any final consolidation step after permeation with the volatile liquid and ablation with the laser.

The particle size not only affects the achievement of the desired porosity but also affects the ablation rate and the surface finish. The ablation rate achieved appears higher for larger sized particles. This is thought to be because with larger sized powder particles there are larger pores filled with volatile liquid so that (a) when the liquid vaporises there is more energy to eject the powder particles, and (b) where a pulsed laser is used, because where there are larger pores in the powder part then any pores voided of liquid during each pulse of the laser more rapidly refill with liquid from adjacent filled pores than would be the case with smaller pores, so that those pores are full of liquid when the subsequent pulse of the laser is applied. Surface finish will be coarser for larger particle sized powders since whole particles tend to be ablated during the process. Preferred particle sizes for the present invention are in the range 1 nm to 1 mm, for example 1 to 150 μm.

As mentioned above, the partial consolidation step of preferred embodiments of the method according to the first aspect of the invention, and according to step I of the method of the second aspect of the invention is carried out such that the partially consolidated part is strong enough to be handled before and after the application of the laser beam without damage, but remains sufficiently porous with weak bonds between particles which can be relatively easily broken during laser processing and so allow material removal. In order to assess whether the strength of the part was sufficient the partially consolidated, e.g. partially sintered, parts were tested by applying a compressive stress by hand (about 125 kPa). If the parts withstand this then they are sufficiently consolidated to be handled.

One step in the methods according to the invention comprises permeating the partially consolidated material with a volatile liquid. This may be conveniently achieved simply by making the porous part (preferably in block form) damp with a few drops of the liquid, or by partially wrapping it in tissue soaked in the liquid. As an alternative the porous part could be placed in a container containing the volatile liquid for a short time, for example less than one hour, especially 5-20 minutes, for example about 10 minutes. In a preferred method, the partially consolidated part is placed in a shallow level of volatile liquid, preferably water, rather than being submerged. Preferably, the level of liquid reaches between one quarter and one half the height of the part, ideally about one quarter. Partial submersion has been found preferable to full submersion, comparative tests indicating that this allows water to soak up through the specimen while air is expelled upwards from the exposed upper surface, while full submersion can cause the liquid pressure to trap the air. (In one test, using water as the volatile liquid, partial submersion led to 93% water ingress while full submersion only achieved 56% ingress.) Submersion is one method of ensuring the part is permeated with liquid prior to laser ablation. It is not usually necessary or convenient to keep the part partially submerged during the ablation.

The step in the method of applying a laser beam to a spot on the surface of the part is preferably carried out by scanning the laser over the part. The spot region where the laser is applied is not usually submerged, although a film (up to 4 mm depth) or spray may be applied to assist in ensuring liquid is still permeating through the part. The laser beam results in rapid heating of the volatile liquid. The rapidly expanding vapour breaks the bonds between the powder particles and either ejects the powder from the part or facilitates the removal of the powder by another means. In this way, for example, a scanning laser beam can be used to follow a two dimensional or three dimensional CAD model e.g. to make a pre-selected pattern or a pre-selected shape and/or both, e.g. to provide a textured surface, or to produce an accurate powder shape. It is advantageous that the volatile liquid is heated rapidly since this means that the liquid becomes superheated before it can vaporise, which tends to result in the liquid “exploding”, which then ejects or at least dislodges the adjacent powder particles. This type of behaviour is sometimes referred to in this technical field as “phase explosion”.

It has been found that it is desirable to select the wavelength of the laser used carefully in order to optimise the ablation process. As described in the above mentioned prior art where laser milling is used, it is traditional for the wavelength to be selected to be one that is strongly absorbed by the material to be ablated. In our invention this is not the case. Indeed specifically it is undesirable if the laser is strongly absorbed by the material itself, since this causes the material to vaporize and possibly redeposit. In contrast in our invention the laser energy is advantageously absorbed not by the material itself but by the liquid which is permeated into the pores of the partially consolidated part in step II of our method. Preferably, in carrying out the laser ablation step, the laser is selected to be one that has a wavelength that an absorption length in the volatile liquid of between 1 mm and 1 m.

For certain embodiments the fluence of the laser is in the range 0.5-10 J/cm², or for some embodiments in the range 1-10 J/cm².

As noted above the volatile permeating liquid may be water. Where the liquid is water the laser preferably has a wavelength in the approximate ranges 180-310 nm or 180-300 nm or 700-1200 nm. These wavelength ranges correspond to absorption lengths in the mm to m range for water.

Absorption length is the distance that light must travel through a medium such that its intensity (I, which is a function of distance z) drops to 36.8% of its value at the surface [I(z)=I₀e⁻¹]. Absorption length is dependent on the medium the laser is travelling in and the wavelength of the laser used. If absorption length is very long, the medium may be described as “transparent” to the laser, the medium absorbing little or no energy from the laser as it passes through the initial distance of the medium. If the absorption length is very short this means that the medium absorbs much of the laser energy in the initial distance of its passage into the medium.

For the present invention if the absorption length of the volatile liquid is too short then all the energy will be absorbed in the liquid immediately adjacent the surface and this will heat and vaporise the liquid at the surface, but will not result in the liquid dislodging or removing any powder particles since the vaporised liquid will be nearer the surface than the particles. At the other extreme, if the absorption length is too long, then the volatile liquid will be effectively transparent to the laser, and there will be no effective heating of the volatile liquid. The skilled man would readily be able to assess the optimum wavelength for good absorption by the liquid to an appropriate absorption length.

As mentioned above it is advantageous if the volatile liquid is heated to a certain depth within the partially consolidated part, since if the heating is restricted to the surface layer only of the liquid then only the surface liquid is vaporised and there is no or little removal of the powder particles themselves that make up the porous part. To this end, as mentioned above, the absorption length of the volatile liquid is preferably tailored by appropriate selection of wavelength for the laser. Additionally the laser wavelength may be selected so that the absorption length of the powder medium itself is such that there is some heating of the powder itself to the depth required for removal, this causing further heat to be transferred to the volatile liquid by thermal conduction from the powder. However advantageously the energy absorbed by the powder particles themselves should not be sufficient to melt the powder particles. To achieve heating of the volatile liquid, it may also be advantageous for the powder particles to be reflective to the laser wavelength, this reflection “scattering” the laser energy at various angles to the direction of the laser beam, between the powder particles and hence transferring further heat to the volatile liquid in the interconnected pores in the powder part.

The fluence or power of the laser that is advantageously used may vary depending, inter alia, on the impregnating liquid used and on the material of the consolidated part used due to different specific heat capacities and thermal conductivities of different materials.

In this technical field it is usual to refer to fluence (which is energy per unit area and is usually measured in J/cm²) for relatively low frequency pulsed lasers, where the energy per unit area of each pulse is important, but to refer to power intensity or power for higher frequency pulsed lasers. There are two distinct values for power density since the lasers are pulsed: one is the average energy per unit time including the gaps between pulses (average power density) and the other is the energy per unit time just during the pulse (peak power density).

As mentioned above application of the laser causes rapid expansion of the volatile liquid. The volatile liquid towards the surface of the part will vaporise, and that deeper in the part will tend to break the bonds between the powder particles and either eject the powder from the part, or weaken the bonds to facilitate the removal of the powder by another means. Where the laser is pulsed, each pulse of the laser will tend to have this effect. In the case of pulsed lasers it may, therefore be advantageous to use a relatively slow laser (e.g. 1-1000 Hz, for example about 10 Hz, in order to allow the volatile liquid to flow from deeper pores in the part, through interconnected pores, to those pores nearer the surface of the part, in order that volatile liquid is present in the pores nearer the surface when subsequent pulses are applied. If, for other reasons, it is desired to use higher frequency lasers e.g. greater than 1000 Hz, for example 3000 Hz, then the surface of the part, and consequently the pores nearest the surface of the part, may advantageously be kept supplied with the volatile liquid by spraying during the laser application.

As mentioned above, the pores in the partially consolidated part are preferably interconnected. The volatile liquid preferably is drawn between adjacent pores by capillary action. Appropriate selection of the volatile liquid may be made to enhance this capillary action, e.g. by consideration of the optimum surface tension and wetting characteristics of the liquid. As previously mentioned water is a suitable volatile liquid for use in this invention. Another suitable choice is ethanol. As also mentioned wetting agents may be added. These enhance refilling of pores at the interaction site with the laser, where pores are voided during the ablation process. If the voided pores are not refilled then further ablation at that site will be affected. For some powder materials, and for some volatile liquids, and for some powder/liquid combinations, it may be desirable to reapply the liquid during the laser ablation. This may be done, for example, by spraying. Thus one embodiment of the invention comprises re-permeating the partially consolidated part with the volatile liquid during the ablation process.

Where the liquid is water and the material making up the porous part is partially consolidated titanium powder, the fluence for an Excimer laser is preferably at least 1 J/cm², preferably at least 1.5 J/cm², or at least 3 or 4 J/cm², or even at least 10, or for higher rates of ablation at least 15 or even 19 or 20 J/cm². Where the liquid is water and the material making up the porous part is partially consolidated aluminium powder, the fluence for an Excimer laser is preferably at least 0.8 J/cm², preferably at least 1 J/cm², or at least 2 or 3 J/cm². Where the liquid is ethanol, the fluence is preferably at least 1.2 J/cm². These fluence levels are significantly lower than those typically used hitherto in prior art laser milling. Typically the provision of lower fluence levels is easier from a manufacturing perspective.

In the prior art, for example in the above mentioned paper “Laser Milling—A practical Industrial solution for machining a wide variety of materials” by Henry et al, average powers of 200 W for an Excimer laser milling Al₂O₃ are quoted, whereas a typical fluence used for our invention for an Excimer laser of 4 J/cm² over a spot size of 2×2 mm at 10 Hz equates to an average power of 1.6 W, i.e. significantly lower than that described in the Henry et al paper.

The laser may be applied as a continuous wave, or pulsed. A range of pulse rates may be used. Pulse length is typically dictated by the nature of the laser system. It has also been found that the rate of ablation (depth per pulse) decreases with increasing number of pulses. This effect can be delayed by increasing the fluence. As an example, for titanium, a depth of material removed of about 0.2-0.4 mm can be achieved at 10 pulses at fluences in the range 1.39-4.44 J/cm².

The process of the present invention provides for much faster ablation rates than in the known laser milling processes. Consequently macroscopic ablation (in the range 0.5 mm up) can be achieved using the present invention (e.g. the 2 mm square spot size previously mentioned) for a whole range of materials including metals, as compared to the more typical microscopic ablation (typically tens of microns up to less than 0.5 mm) achieved with the typical prior art laser milling techniques applied to metals.

The laser spot size may be at least 1.5 times, or even at least twice the average powder particle size. Advantageously this provides for good material removal with low oxidation.

The effect of applying the scanner laser beam to a spot on the surface of the liquid-permeated part is to cause the volatile liquid to heat and vaporise in the spot region, causing the partially consolidated powder particles to separate in the spot region, so that a portion of the part is removed (ablated), or can be removed (ablated) in the spot region.

Where the partial consolidation of the powder is carried out by sintering, or by other process involving heat, then the vaporisation of the liquid in the spot region is thought to generate a pressure which breaks the weak “necks” between the partially consolidated particles, those weak necks between adjacent particles having been formed by diffusion bonding during the sintering, or other elevated temperature partial consolidation step.

Where the partial consolidation of the powder is carried out by a cold pressure technique such as cold isostatic pressing (CIPing), adjacent particles in the partially consolidated powder are mechanically interlocked, but not actually bonded. In this case, in a similar manner, the vaporisation of the liquid in the spot region is thought to generate a pressure which breaks apart the mechanical bond.

There is no need to melt the material of the partially consolidated part itself. The volatile liquid may advantageously be selected to have a significantly lower vaporisation temperature than that of the consolidated material itself, so much lower temperatures, and consequently typically much lower energy will be needed to ablate materials using the method of the present invention compared with the typical laser milling techniques known in the prior art in which it is the material of the compact itself which needs to be vaporized by the laser. Keeping the temperature lower is also advantageous since it avoids thermal damage to the part.

The temperature of the material achieved during the process is preferably sufficient to cause a small amount of superficial melting of the powder particles, but not so high as to significantly melt the material. It is also advantageous for the heat conduction to be low so that only a superficial layer is melted. For titanium powder, the temperature achieved in the material is preferably about 1670° C. An average power to achieve this for an Excimer laser is preferably about 0.8-1.6 W (equating to 2-4 J/cm² for a spot size of 2×2 mm).

Preferred embodiments of the method according to the first aspect of the present invention, and step IV of the method according to the second aspect of the invention, comprises further strengthening the part. This step may comprise further consolidation, for example further sintering the part, preferably at a high temperature, and/or hot isostatic pressing. Another possible technique for the further strengthening of the part is infiltration with a different metal or alloy. This may be achieved by putting the partially consolidated part in contact with some molten metal (of a lower melting temperature), the molten metal being drawn into the pores by capillary action. For certain materials, e.g. for titanium, the strengthening step may comprise sintering at a temperature in the range 1200-1400° C. This step may advantageously produce a high density near-net-shape. The term near-net shape refers to the production of the item to a shape very close to its final (net) shape. It is one of the advantages of consolidation processes that near-net-shapes can be manufactured thereby reducing traditional cost-intensive finishing techniques such as machining or grinding.

Depending on the application, full (100%) densification may not be required. Some parts will go into service with porosity present and have the necessary properties for the application. Indeed for some applications 100% densification is undesirable. For example, for an application such as a filter, the part will be required to have a predetermined porosity present in the final part. A sintering process, post ablation, can typically be used to increase the density of a part up to about 80%, 90% or in some cases even 99%. Above about 95% density the porosity will become isolated, i.e. not connected to the surface and if higher densities are desired a process such as hot isostatic pressing (HIPing) may advantageously be used to achieve densities up to full (100%) densification.

As mentioned above in the known laser milling techniques, used in the prior art on solid materials such as solid titanium, water is applied only on the surface. For titanium and other heat sensitive material the laser milling is relatively slow and may result in a damaged surface layer because of the high temperatures needed to vaporise the titanium. We have found in some of our comparative tests that surface damage of dry, partially consolidated materials may similarly occur, this being thought to be due to overheating and fusing of the powder particles progressively reducing their removal rate and halting the milling process. In contrast in our invention, by impregnating the compact with volatile liquid, e.g. water or ethanol, and selecting the appropriate laser parameters it is possible to remove material rapidly and precisely, without causing overheating of the underlying material and allowing the ablation to continue at an optimum rate.

The invention may advantageously achieve a shaped or textured surface, or a shaped part, e.g. a complex shaped part, without requiring expensive tooling. It may therefore find particular application for producing prototypes or small numbers of parts where the cost of tooling for powder processes such as injection moulding or die pressing and sintering would be prohibitive. It could be particularly applicable in the production of one-off parts such as bespoke medical implants where the shape could be made, for example, using data degenerated from a medical scan. Another application is the manufacture of precision moulds, e.g. ceramic moulds for metal casting. The method may also find application in the aerospace industry. It could also be used for laser drilling, surface texturing, laser cleaning, mining, stone cutting, sculpting, decorative art production, demolition, or dismantling.

In a further aspect, there is provided a method of manufacturing a shaped part, the method comprising:
(I) providing a porous part that has been made from a powder and has weak bonds between the powder particles;
(II) permeating the porous part with a volatile liquid, so that the liquid is present in the pores of the porous part; and
(III) forming the shaped part by applying a laser beam to a spot on the surface of the liquid-permeated part to cause the volatile liquid to heat in the spot region, causing the powder particles to separate in the spot region, so that a portion of the part is ablated in the spot region.

The method is applicable to any porous article that is sufficiently porous with weak bonds between particles that can be relatively easily broken during laser processing and so allow material to be removed. Usually special steps will have been taken to engineer an article with this degree of fragility.

Sintered shaped powder parts were made according to the method of the present invention according to the following examples, and as illustrated, by way of example only, with reference to the accompanying drawings, wherein:

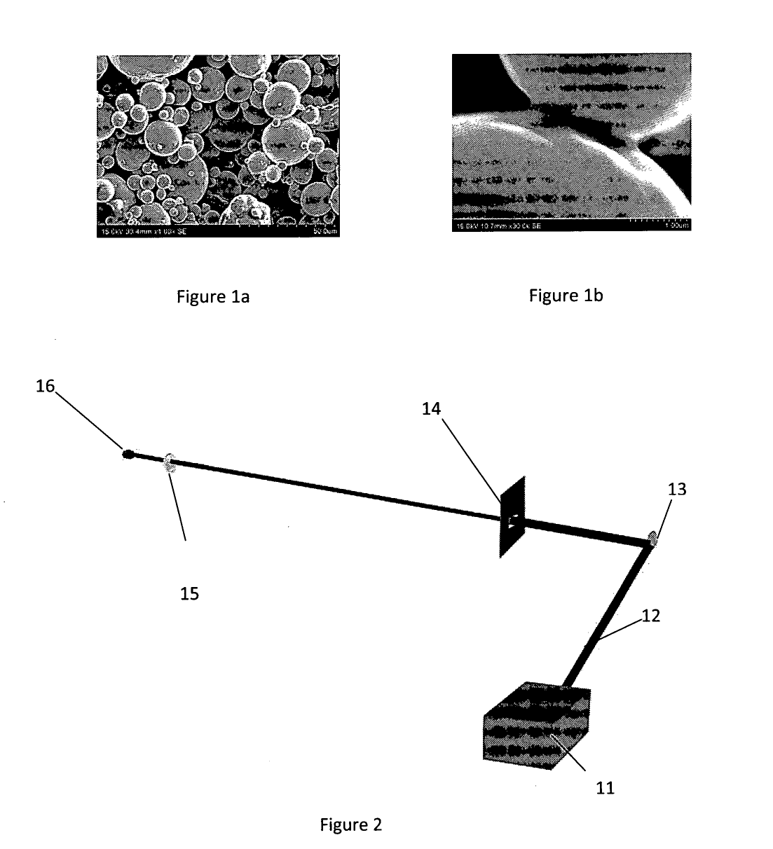

FIGS. 1a and 1b are SEM micrographs at different magnifications of a partially sintered titanium powder according to step I of the method according to the invention;

FIG. 2 is a schematic drawing showing the experimental set up for laser ablation according to the invention;

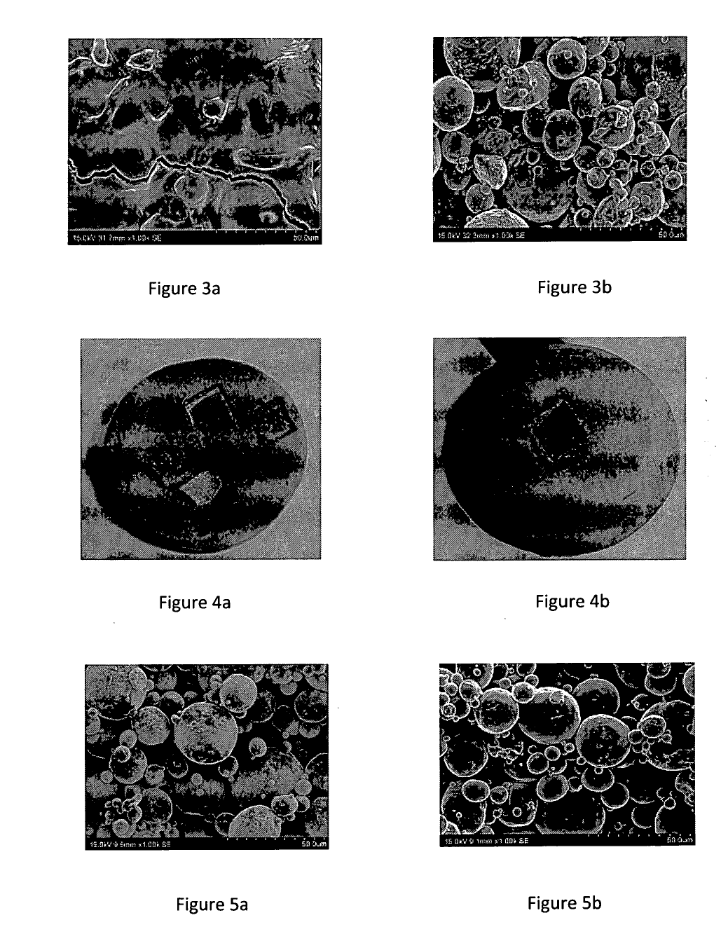

FIGS. 3a (comparative) and 3b are SEM micrographs of, respectively, a dry partially consolidated titanium powder sample, and a water-permeated partially consolidated titanium powder sample, that have each been scanned with an Excimer laser;

FIGS. 4a (comparative) and 4b are photographs of, respectively, a dry partially consolidated titanium powder sample and water-permeated partially consolidated titanium powder sample, that have each been scanned with a Nd:YAG laser;

FIGS. 5a and 5b are SEM micrographs of partially consolidated water-permeated titanium powder samples irradiated respectively by a 532 nm Violino laser and a 1064 Violino laser;

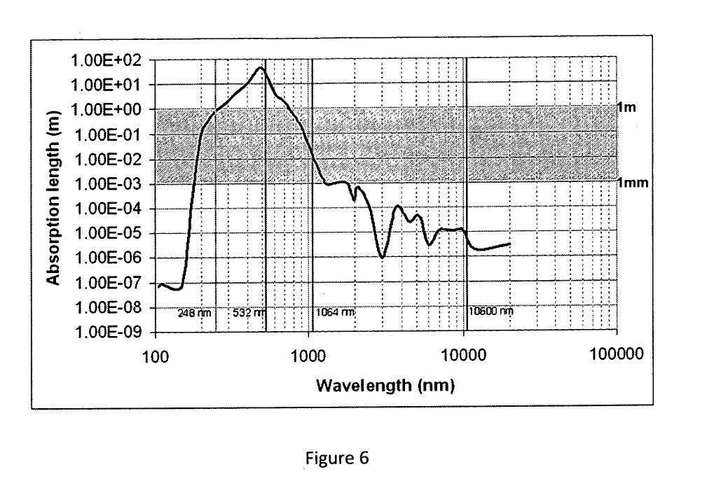

FIG. 6 is a graph showing how the absorption length in water varies for light of different wavelength;

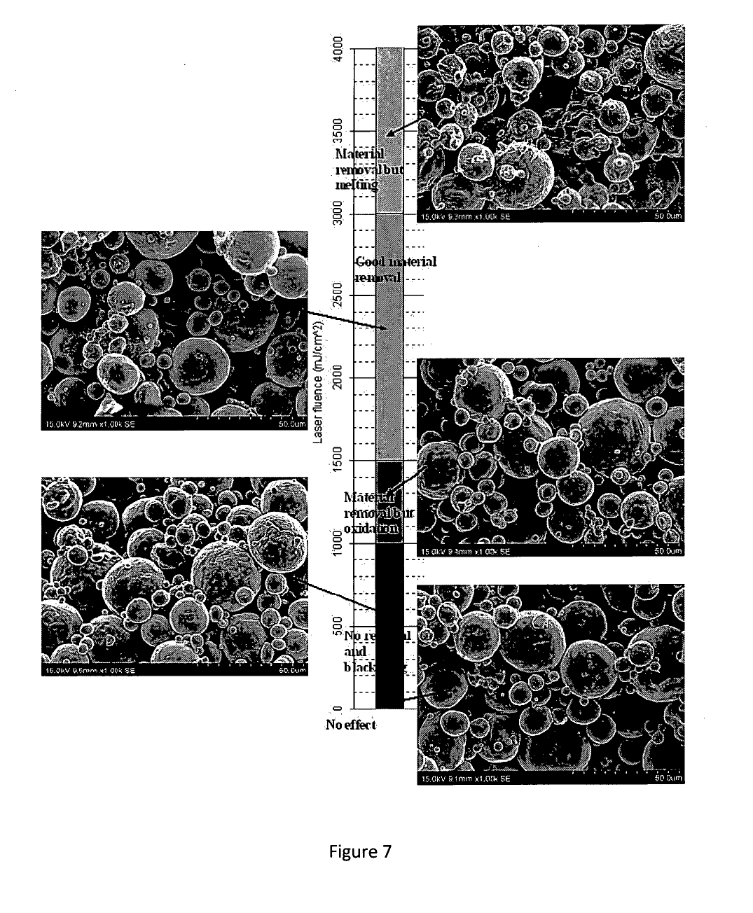

FIG. 7 is a series of SEM micrographs showing the effects of using a scanning Excimer laser of different fluences on a water-permeated titanium powder sample;

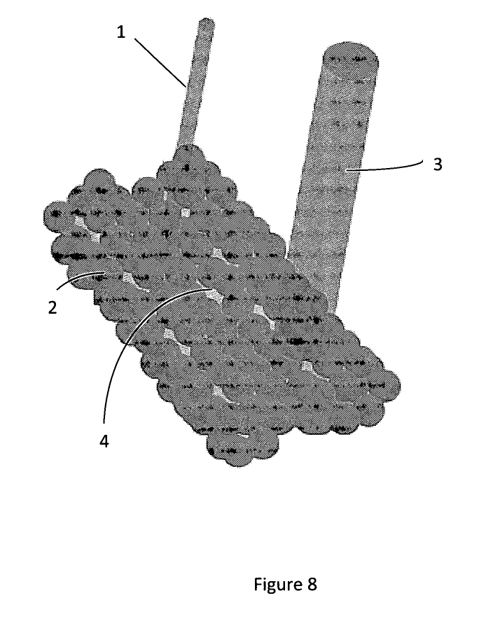

FIG. 8 is a schematic drawing showing the heating area resulting from lasers beams of different diameters on the sample surface;

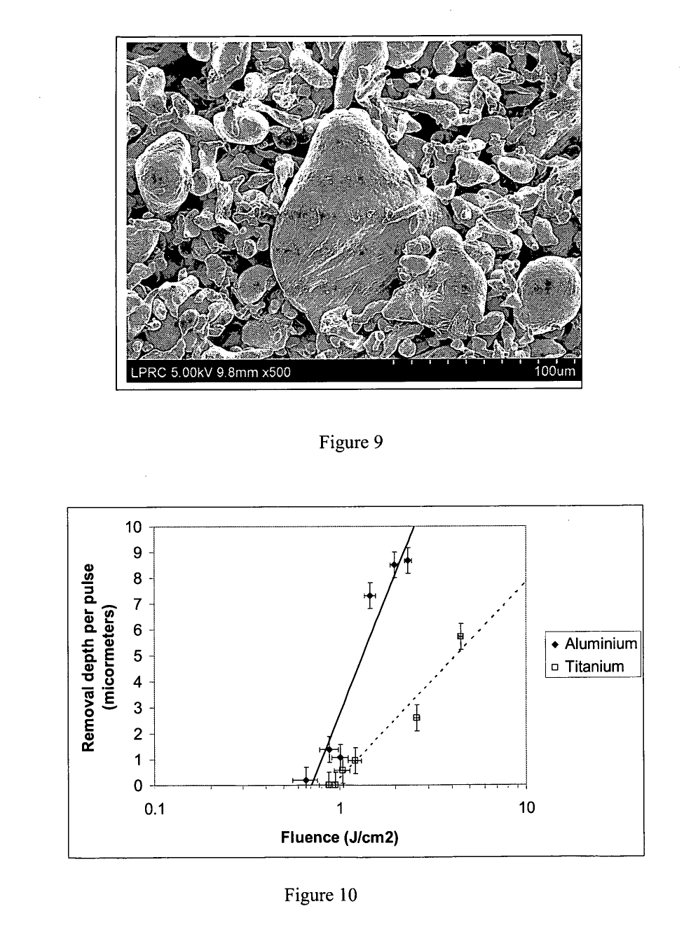

FIG. 9 is a SEM micrograph of aluminium powder after partial sintering;

FIG. 10 is a graph showing the removal rate variation with fluence during ablation of partially sintered and consolidated aluminium powder and titanium powder;

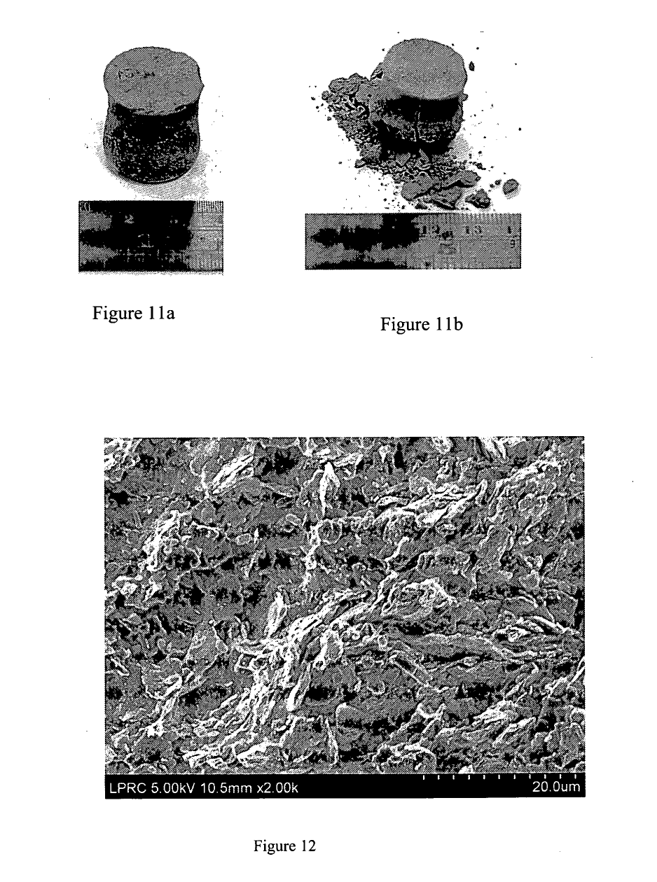

FIGS. 11a and 11b are photographs of a CIPed cordierite specimen after the CIPing process, respectively before and after partially immersing in water for 30 minutes;

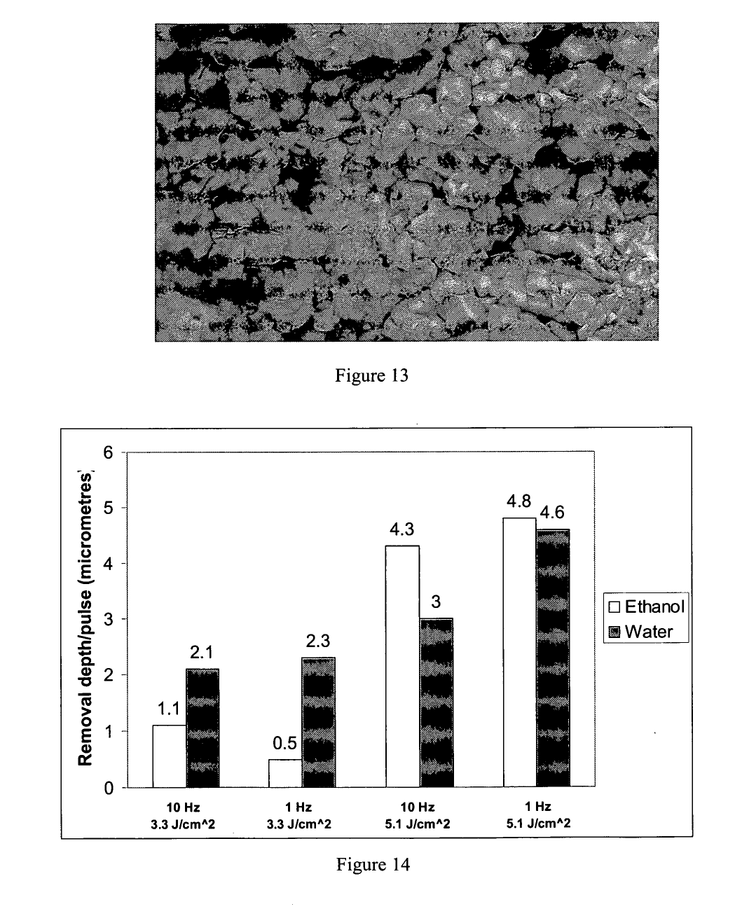

FIGS. 12 and 13 are SEM micrographs of CIPed steatite and CIPed alumina specimens respectively;

FIG. 14 is a graph showing the removal rates on ablation of two sets of partially sintered and consolidated titanium powder specimens, the first set having been partially immersed in water, and the second set partially immersed in ethanol, testing being carried out with an Excimer laser at different fluences and frequencies;

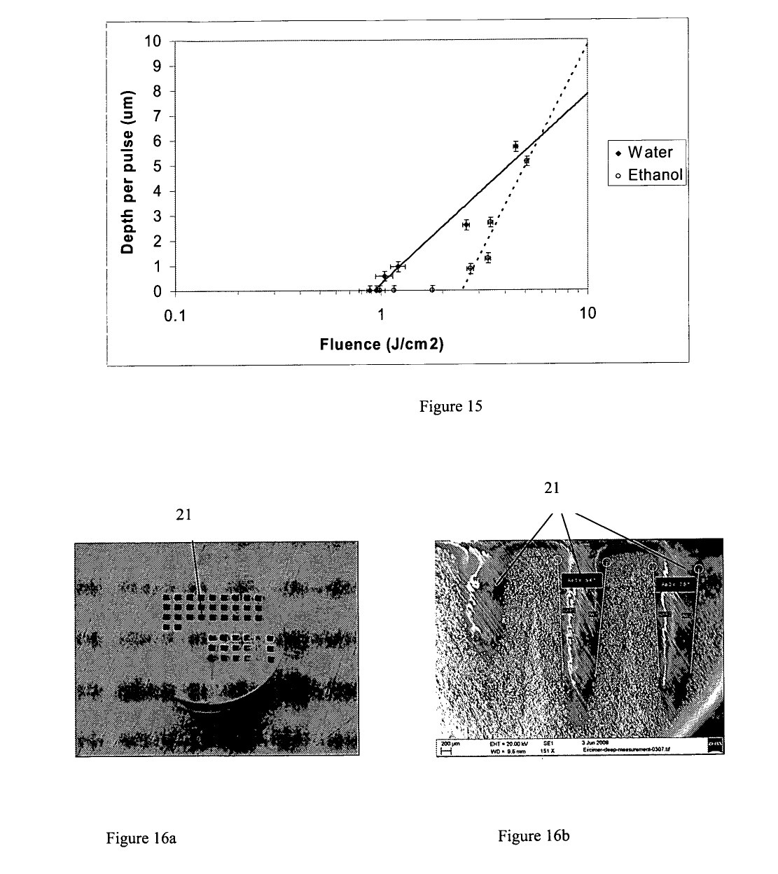

FIG. 15 is a graph showing the variation of removal rates on ablation with changing fluence, for ethanol and water as the volatile liquid, on the titanium specimens; and

FIGS. 16a and 16b are a photograph and cross-sectional micrograph respectively, showing holes made using the method according to the invention.

### EXAMPLES

A. Examples Using Water as the Volatile Liquid

A.1 Examples Using Titanium Powder

Commercially pure (ASTM B348 Grade 2) titanium powder of size distributions <45 μm and 45-150 μm diameter supplied by QinetiQ Ltd. was used for the specimen preparation.

Approximately 30 g of titanium powder was placed in an alumina crucible which was then vibrated to its tap-density. The crucible was put in a tube furnace and subjected to a heating cycle under an argon atmosphere in order to partially sinter the powder. The heating cycle was optimised to produce the desired level of sintering. To achieve this a range of temperatures was investigated. The requirement of the sintering was that it produced a block of titanium powder which was strong enough to be handled before and after laser processing (so that fine features and structure would not be damaged) but would be sufficiently porous with weak bonds between particles which would be relatively easily broken during laser processing and so allow material removal. The strength of the resulting blocks was tested by applying a compressive stress by hand (-125 kPa). The lowest temperature which produced a block which could withstand this pressure was considered the best condition. The optimum results for the <45 μm powder were found to be a heating cycle of: 1) Rapid heating to 700° C., 2) 20 minute hold at this temperature followed by 3) slow cooling to room temperature. For the 45-150 μm powder, a hold temperature of 750° C. was considered optimum. The sintering process preferably achieves 60% full density. The sintered block's surfaces were then ground to provide a flat area for laser processing.

The surface of the partially sintered blocks is shown in the SEM micrographs of FIG. 1. FIG. 1a shows the general morphology and FIG. 1b shows a high magnification image of a ‘neck’ formed during sintering. From these figures the pores between the “necked” sintered parts can be seen. The volume fraction of the pores in this example is about 0.4. Each pore itself is about 10-20μm across, and pores are interconnected.

A block of the partially sintered titanium was placed partially submerged in water and left for 10 minutes until the water had soaked into the interior via the interconnected network of pores, and preferably filled the interconnected pores. After soaking, the block was removed from the water and placed in a clamp on a computer controlled stage where it was subjected to laser ablation.

The laser experiments were conducted using the systems shown in Table I.

TABLE 1
Laser system parameter

| | | Violino | Violino | | |
|---|---|---|---|---|---|
| | Excimer | Green | IR | Quantum | Spectron |
| Type | KrF | Nd:YVO₄ | Nd:YVO₄ | Nd:YAG | CO₂ |
| Wavelength (nm) | excimer | 532 | 1064 | 1064 | 10600 |
| | 248 | | | | |
| Pulsed or continuous wave | Pulsed | Pulsed | Pulsed | Pulsed | cw |
| Maximum average | 100 | 7.2 | 4 | 11 | 130 |
| power (W) | | | | | |
| Minimum spot diameter | — | 30 | 50 | 110 | 230 |
| (μm) | | | | | |
| Pulse width (ns) | 20 | 8 | 8 | 100 | N/A |
| Repetition rate (Hz) | 1-200 | 20000-80000 | 30000 | 1000 | N/A |

Experiments were carried out using the above laser systems on specimens of partially sintered titanium powder of both size ranges. The experiments compared the effect of laser parameters on the effectiveness of the process. In particular, laser wavelength, laser spot size, laser power and the presence of water were investigated. Another suitable laser that could be used is a XeCI laser.

FIG. 2 is a schematic drawing showing the experimental set up for laser ablation. A laser source 10 provides a laser beam 11 that is directed via a mirror 12, through a mask 13 and imaging lens 14, to a work piece 15 placed in a clamp on a computer controlled stage.

The Excimer and Quantum lasers were used to perform comparative experiments with and without the presence of water in the specimens. FIG. 3 shows SEM micrographs of the surface of a specimen partially sintered from the <45 μm powder which has been irradiated by the Excimer laser with (i.e. according to the invention) and without (i.e. a comparative example) having been soaked beforehand in water. FIG. 3a shows the comparative example without water where there is zero removal depth, and FIG. 3b shows the example according to the invention with water which shows 0.19 mm removal depth. In each case the laser is applied at fluence of 1.8 J/cm² and for 10 pulses. The experiments conducted covered a range of laser fluences from 1.0 J/cm² to 5.0 J/cm² and it was observed that when there was no water present, there was no material removal; instead, the titanium powder particles were melted into a solid layer (FIG. 3a). When water was present (FIG. 3b), material was removed and the underlying surface retained its porosity although there was some superficial melting of the particles. Thus it can be seen that the presence of the water is very important for removal of the material. It is thought that this is due to the water absorbing the laser energy and heating causing it violently to expand and force out, or loosen, the overlying material. Thus the use of water appears to change the material removal mechanism. Similar results were observed for the Quantum laser.

FIG. 4 shows the results of similar experiments using the Quantum IR laser with the following conditions: pulse duration=100 ns; repetition rate=1 kHz; average power=11 W; laser fluence=116 J/cm²; peak intensity=1.16×109 W/cm². When no water is present (FIG. 4a), there was no material removal even at the maximum power of the laser. Instead, the scanning laser beam caused a thin surface layer of titanium powder to melt as the beam passed which rapidly re-solidified into a ‘scab’ of titanium. Subsequent passes of the laser beam were then blocked by this scab and no material was removed. After the experiment, the scab was easily detached from the underlying partially sintered powder and two such sites and the dislodged scabs can be seen in FIG. 4a. Using the same laser parameters but with the specimen presoaked in water, material removal does occur and there is no scab formation (FIG. 4b).

There appears to be a threshold fluence below which ablation does not occur. The following calculations show the laser fluences used in the Excimer and Violino IR experiments are below the threshold for ablation of titanium according to the standard processes of laser milling in which it is the titanium itself which is vaporising under the action of the laser to effect the ablation. For ablation to occur according to the standard laser milling process, the absorbed energy would have to be equal to or greater than the enthalpy of vaporisation of the material. For titanium this is

Δhₜₒₜₐₗ=Δh_{T=300→T}_{ₛₗ}+Δhₛₗ+Δh_{T}_{ₛₗ}_{→T}_{_{b}}+Δhₗᵥ=133.2 kcal/mol=11.65×10⁶ J/kg

The mass of titanium which would need to be vaporised is therefore:

$$m = ρ γ \frac{π {D}^{2}}{4} δ$$

where m is the mass (kg), p is the density of titanium (kg/m³), γ is the volume fraction occupied by powder particles in the pressed compact, D is the laser spot diameter (m) and δ is the absorption depth into the powder bed of the radiation (m). A typical value for δ in laser irradiation of a titanium powder bed is 65 μm. The volume fraction of sintered titanium powder is 0.6 and p=4500 kg/m³. Therefore the energy required to vaporise this mass of titanium is about 19 mJ or a fluence of 200 J/cm². The laser pulse energy is given by average power/frequency so for the Quantum IR laser it is 11 mJ. Therefore, even if the all the incident radiation were absorbed, ablation would not occur by vaporisation of the titanium according to the standard laser milling process. The same calculation shows that for complete melting, a pulse energy of greater than 2.55 mJ is required (fluence >27 J/cm²). These calculations therefore confirm the observations from the samples that the water is playing an important role in the removal mechanism, and as mentioned above it is thought that this is due to the water absorbing the laser energy and heating causing it violently to expand and force out, or loosen, the overlying material.

To demonstrate the effect of varying the wavelength on the effectiveness of the ablation a number of tests were done. Firstly, comparative experiments were done using the two Violino lasers: the 532 nm wavelength and the 1064 nm wavelength Violino lasers, since the other parameters of these two lasers are very similar (see Table I). A specimen of partially sintered <45 μm powder which had been soaked in water for 10 minutes was placed on the stage beneath the laser and scanned by each laser at a scanning speed of 50 mm/s.

In the case of the 1064 nm laser, a fluence of 0.42 J/cm2 (Intensity=6.063×10⁷ W/cm²) was found to give the best results in terms of material removal and prevent excessive melting of the powder. Fluences of greater than 1 J/cm² tended to melt the powder into a solid layer preventing effective processing and there was no material removal when the fluence was greater than 1.7 J/cm². An example of material removal rates for the 1064 nm laser operating at a fluence of 0.42 J/cm² was that 10 scans of the raster produced a material removal depth of about 1 mm (removal rate of 25 mm³/min or 68 mg/min).

In the case of the 532 nm laser, a range of fluences from 0.30-22.0 J/cm² were tested. However, the 532 nm laser produced no material removal whatsoever, and either had no effect on the sample (F<5 J/cm²) or caused discoloration due to oxidation and change in the surface texture turning the surface dark blue or black F>5 J/cm²). FIGS. 5a and 5b show two typical irradiation sites from the two lasers. The damage to the powder particles' surfaces caused by the 532 nm laser (FIG. 5a) can be seen showing that this laser results in excessive heating of the powder bed rather than producing the more ‘clean’ removal seen in the case of the 1064 nm laser (FIG. 5b).

The Excimer (wavelength=248 nm) and CO₂ (wavelength=10600 nm) lasers were also used to compare the effect of their wavelengths on the process. The excimer (wavelength=248 nm) produced very good results, even better than those of the 1064 nm Violino in terms of material removal and lack of oxidation of the surface. The CO₂ laser (wavelength=10600 nm) gave very poor results with no effect at low powers and melting of the titanium but no material removal when the power was increased.

The excimer laser (248 nm) has an absorption length in water of ˜1 m meaning that a layer of water 1 mm deep would absorb 0.1% of the light. In the case of the CO₂ laser, the absorption length for pure water is ˜5 μm meaning that the water is practically opaque to the light and it does not penetrate to any significant depth which would appear to prevent the material removal mechanism from occurring. In addition, titanium is highly reflective to this wavelength meaning that high power densities would be required.

Energy absorption by water is dependent on wavelength. FIG. 6 is a graph showing the absorption length for light of different wavelengths in water as the medium, which graph was calculated from published data. The trialled laser wavelengths: 248 nm, 532 nm, 1064 nm and 10600 nm are superimposed thereon. Absorption length is medium dependent so a different liquid may have a different light absorption length spectrum. As discussed previously, the medium should not absorb the laser energy too quickly or too slowly, and the present inventors chose to select laser wavelengths that have an absorption length of between 1 mm and 1 m for any chosen liquid medium (i.e. the light will travel for between 1 mm and 1 m in that liquid before its intensity drops to about 36%). From FIG. 6 it can be seen that the laser wavelengths for use in the case of water as the volatile liquid is roughly in the range 180-320 nm or 700-1200 nm; thus, only the 248 nm and 1064 nm lasers fall inside these bands and would be suitable, as was confirmed by the present trials. Depending on the powder material being ablated, a further down selection of a narrower band of wavelengths may be needed, if certain wavelengths are still unsuitable, for example, because they still cause undue heat damage. Appropriate selection of wavelengths for other chosen volatile liquids and chosen powder materials would therefore be apparent to the man skilled in the art.

There is a significant difference in the absorption of water at the different wavelengths of the two 532 nm and 1064 nm lasers. The absorption length of pure water is about 10 m (for a wavelength of 532 nm) and about 10 mm (for a laser wavelength of 1064 nm).

Using the Beer-Lambert law, the amount of energy absorbed by the water for the different lasers can be estimated by the following equation:

I(z)=I₀ exp[−4πkz/λ]

where I(z) is the intensity as a function of depth into the material (z), I₀ is the intensity at the surface of the material (z=0), A is the laser wavelength and k is the material dependent extinction coefficient.

This means that a layer of water 1 mm deep will absorb approximately 0.01% of the optical energy for the laser of wavelength 532 nm whereas it will absorb about 9.5% of the optical energy for a laser of wavelength 1064 nm. The actual depth of water on the samples varies over the surface due to the inhomogeneous nature of the pores and is determined, inter alia, by the powder particle size and degree of sintering. Therefore, this difference in the lasers' ability directly to heat the water affects the material removal process.

Tests were also carried out to show the effect of fluence on the ablation method. Using the Excimer laser with specimens of the water-permeated <45 μm powder, a range of fluences from around 50-5000 mJ/cm² were used. Comparative tests were carried out by using 10 pulses at the given fluence to a specimen and the site was then examined via SEM to see the effect on the particles at the bottom of the irradiation site. The experiments showed that there are five different ranges where different effects to the underlying particles could be seen. The results are shown in Table 2 below.

TABLE 2

| Fluence in | |
|---|---|
| mJ/cm² | Result |
| <100 | No effect |
| 100-1000 | Blackening of the surface but no material removal |
| 1000-1500 | Material removal but some oxidation |
| 1500-3000 | Good material removal |
| >3000 | Material removal but some melting of remaining particles. |

From these results it can be seen that the preferred fluence for an Excimer laser on water-permeated partly consolidated titanium powder parts is in the range 1-3 J/cm2.

Thus these results show that there is a threshold fluence below which no laser ablation occurs. The results also show that too high fluence, at least in these specimens, causes excessive melting. Such excessive melting may inhibit further material removal.

FIG. 7 shows the SEM micrographs at each of the fluences shown in Table 2.

For completeness, Table 3 summarises the results from the above mentioned experiments, so that the effects of the different variables can be more easily compared. All results shown in Table 3 were carried out on partially sintered <45 μm titanium powder. (Table 3 incorporates the results from Table 2.)

TABLE 3

| | | Absorption | | | | |
|---|---|---|---|---|---|---|
| | | length in water | Fluence | Water | Material | |
| Type of Laser | λ (nm) | (m) | (J/cm²) | added ? | Removal ? | Observations/Comments |
| Excimer | 248 | 1 | 1.8 | No | No | FIG. 3a COMPARATIVE |
| Excimer | 248 | 1 | 1.8 | Yes | Yes to 0.9 mm | Underlying surface retained porosity. |
| | | | | | | Some superficial melting of particles. |
| | | | | | | No or little oxidation of surface FIG. 3b |
| Quantum IR | 1064 | ~2.5 × 10⁻² | 16 | No | No | Thin surface layer of titanium powder |
| | | | | | | melts and resolidifies into a scab of |
| | | | | | | titanium. FIG. 4a COMPARATIVE |
| Quantum IR | 1064 | ~2.5 × 10⁻² | 16 | Yes | Yes | No scab formation FIG. 4b |
| Violino | 1064 | ~2.5 × 10⁻² | 0.42 | Yes | Yes to 1 mm | Good material removal. No |
| | | | | | | excessive melting of powder |
| Violino | 1064 | ~2.5 × 10⁻² | >1 | Yes | Some | Melting of powder into a solid layer |
| | | | | | | preventing effective processing. |
| Violino | 1064 | ~2.5 × 10⁻² | >1.7 | Yes | No | No material removal at all. |
| Violino | 532 | ~25 | 0.3 to <5 | Yes | No | No effect on surface |
| Violino | 532 | ~25 | 5-22 | Yes | No | Discolouration of surface due to oxidation. |
| | | | Fluence | | | |
| | | Absorption | (J/cm²) | | | |
| | | length in water | or Power * | Water | Material | |
| Type of Laser | λ (nm) | (m) | (W/cm²) | added ? | Removal ? | Observations/Comments |
| CO₂ * | 10600 | 5 × 10⁻⁶ | 1040 | Yes | No | No effect |
| CO₂ * | 10600 | 5 × 10⁻⁶ | 1540 | Yes | No | Melting of the titanium, |
| | | | | | | but no material removal |
| Excimer | 248 | 1 | <0.1 | Yes | No | No effect |
| Excimer | 248 | 1 | 0.1-1 | Yes | No | Blackening of the surface |
| | | | | | | but not material removal |
| Excimer | 248 | 1 | 1-1.5 | Yes | Yes | Material removal but some oxidation |
| Excimer | 248 | 1 | 1.5-3 | Yes | Yes | Good Material removal |
| Excimer | 248 | 1 | >3 | Yes | Yes | Material removal but some |
| | | | | | | melting of remaining particles |

* Power quoted for CO₂ laser. Fluence for other lasers

The experiments showed that for the same power density, if the spot size were below a certain value, no removal occurred. The experiments were done on both size distribution powders and it was found that the laser spot size should advantageously be at least twice that of the powder particles for there to be good material removal and low oxidation.

A beam of diameter similar or less than that of the powder particles will tend to heat just one or two particles with each pulse whereas it appears that the material removal mechanism relies on the direct heating of the surrounding water in the pores and not just on heat transfer from the titanium to the water. This agrees with the results from the laser wavelength experiments which showed that light at wavelengths transparent to water gave no successful results. FIG. 8 is a schematic drawing showing a laser beam 1 of small diameter which tends to heat only one particle 2 at a time, heat needing to be transferred by thermal conduction through the particle to the water, and a second larger laser beam diameter 3 which tends to heat the whole particle 2 AND the surrounding water 4.

Tests on 45-150 μm diameter titanium material samples sintered at 900° C. for 20 minutes then permeated with water and then scanned with a laser were found not to ablate. These samples represent samples in which the initial partial consolidation step has been overdone, resulting in a part with bonds that are too strong to be easily broken during the laser ablation process.

A.2 Examples using Aluminium Powder

Two grades of aluminium powder were used for these examples:
1. irregular shaped particles of pure aluminium powder
2. spherical shaped particles of 99.94% pure aluminium powder.

A number of aluminium specimens of each grade of powder were prepared by partially sintering aluminium powder in a tube furnace in the same way as described above for the titanium powder for the titanium specimens. Experiments showed that heating to 600° C. and then holding for 20 minutes followed by a slow cooling to room temperature gave good results for both grades of aluminium. The ‘window’ for good partial sintering (i.e. that which gave a specimen strong enough to be handled but not too strong to be laser processed) was found to be smaller than that for the titanium specimens, and it was found that at least for the irregular shaped particles of aluminium, if sintering conditions were not optimised then friable specimens could result, which were subsequently difficult to reliably and accurately ablate.

FIG. 9 is a SEM micrograph showing the irregular shaped particles of aluminium powder after partial sintering at 600° C. for 20 minutes. As can be seen from the micrograph, the particles have high aspect ratios and the porosity is also high. The particles are very irregular in shape, with wide size variation, ranging from <10 to 100 μm.

Some of the partially sintered aluminium specimens were left dry for comparative laser ablation testing as described later. The remaining aluminium specimens were partially submerged in a beaker of water so that the water came up to a level ¼ of the height of the specimen. The block was left for 24 hours to allow water to absorb into the block, and the mass was measured after 10 minutes and after 24 hours. The measured mass was compared with the theoretical maximum if all the pores were filled with water, and the water infiltration percentages calculated from the mass values. The porosity and water infiltration percentages are set out in Table 4 below.

TABLE 4
Porosity and Water infiltration Percentages for Aluminium

| | Type 1 | |
|---|---|---|
| | Irregular | Type 2 |
| | shaped | Spherical |
| Property | particles | particles |
| Measured density of block of partially | 1257 | 1290 |
| sintered aluminium (kg/m³) | | |
| Bulk density of aluminium (kg/m³) | 2700 | 2700 |
| Volume fraction of solid in block | 47% | 48% |
| [(1257/2700) × 100)] | | |
| Volume fraction of pores in block | 53% | 52% |
| Percentage water infiltration after 10 minutes | 98% | 89% |
| Percentage water infiltration after 24 hours | 100% | 100% |

From the table it can be seen that significantly porous parts (52-53% pores) are achieved for both types of aluminium, which absorb water quickly (pores being 89-98% filled after 10 minutes).

The water-soaked partially sintered aluminium specimens were then removed from the water and placed on a stage and subjected to laser ablation using an Excimer laser having the parameters defined in Table 1 above. The dry partially sintered aluminium specimens were subjected to the same laser conditions as the water soaked specimens for comparison. The laser was set up with a fluence of 2.5 J/cm², this being in the range 1.5-3 J/cm² that had been shown to give good material removal on the titanium specimens. Both water-soaked and dry aluminium specimens were subjected to a range of numbers of laser pulses ranging from 10 to 100 pulses.

The results were similar to those from the titanium specimens used previously in that there was no material removal without water and some material removal when water was used. The depth of removal after 100 pulses was around 0.6 mm. The aluminium part made from the sintered particles was then subjected to further experiments using the Excimer laser at different fluences to determine the threshold fluence below which no ablation occurred and to determine the relationship between fluence and rate of ablation (removal depth/pulse). These results were compared with results for similar tests carried out on titanium specimens, and the results for both materials are shown in the graph in FIG. 10.

From the graph it can be seen that there is a lower threshold fluence for the aluminium powder part (0.7 J/cm2) than for the titanium powder part (0.9 Jcm2). The second observation is that the different gradients of the two t trend-lines which express Beer's law

x=α⁻¹ ln(F/F_{T})

with x being depth, F being fluence and FT being threshold fluence. The gradient is therefore α⁻¹ which is the inverse of the effective absorption coefficient for the material.

A.3 Examples using Cordierite, (Mg, Fe)₂Al₄Si₅O₈

Cordierite ceramic specimens were made by Cold Isostatic Pressing (CIPing) of cordierite powder, using a range of pressures from 20 to 376 MPa for 2 minutes, plus the time to raise and lower the pressure.

FIG. 11a shows a typical CIPed Cordierite specimen after the CIPing process and prior to water soaking. The CIPed cordierite specimens were then partially submerged in a beaker of water so that the water came up to a level ¼ of the height of the specimen. FIG. 11b shows the specimen of FIG. 11a after submersion in water for 30 minutes. It was observed that the sample cracked and disintegrated when the water was absorbed. Cordierite is therefore not a suitable powder material for the present invention. Thus is can be observed that only certain ceramics are suitable for use in the present invention; only those that do not dissolve or disintegrate in water.

No further testing was done on the cordierite specimens.

A.4 Examples using Steatite MgO SiO₂

Steatite ceramic specimens were made by Cold Isostatic Pressing (CIPing) of steatite powder, using a pressure of 50 MPa for a time of 2 minutes, plus the time to raise and lower the pressure.

FIG. 12 is a SEM micrograph showing the CIPed steatite specimen after grinding of the surface to show the particle morphology. As can be seen from the micrograph, the particles have an irregular shape, and are plate-like in shape, making packing relatively dense. The particles are typically less than 5 μm in size, and there is low porosity resulting from the relatively dense packing caused by the plate-shaped particles.

Some of the CIPed steatite specimens were left dry for comparative laser ablation testing as described later. The remaining steatite specimens were partially submerged in a beaker of water so that the water came up to a level ¼ of the height of the specimen. The block was left for 24 hours to allow water to absorb into the block, and the mass was measured after 10 minutes and after 24 hours. The measured mass was compared with the theoretical maximum if all the pores were filled with water, and the water infiltration percentages calculated from the mass values. The porosity and water infiltration percentages are set out in Table 5 below.

TABLE 5
Porosity and Water infiltration Percentages for Steatite

| | |
|---|---|
| Measured density of block of partially CIPed | 2094 |
| steatite (kg/m³) | |
| Bulk density of steatite (kg/m³) | 2500 |
| Volume fraction of solid in block | 84% |
| [(1257/2700) × 100)] | |
| Volume fraction of pores in block | 16% |
| Percentage water infiltration after 10 minutes | 35% |
| Percentage water infiltration after 24 hours | 100% |

From the table it can be seen that the porosity is low and does not absorb water quickly (pores only 35% filled after 10 minutes). However good water absorption (100%) was obtained after 24 hours.

The water-soaked CIPed steatite specimens were then removed from the water and subjected to laser ablation using an Excimer laser having the parameters defined in Table 1 above. The dry CIPed steatite specimens were subjected to the same laser conditions as the water pre-soaked specimens for comparison. The laser was set up with a fluence of 2.5 J/cm², this being in the range 1.5-3 J/cm² , with a repetition rate of 10 Hz, that had been shown to give good material removal on the titanium specimens. Both water-soaked and dry steatite specimens were subjected to a range of numbers of laser pulses ranging from 10 to 100 pulses.

It was observed that for the dry steatite specimens, there was no effect from the laser pulsing even after 100 pulses. For the water-soaked steatite specimens, there was noticeable removal even after 10 pulses. The maximum depth that could be removed was about 0.5 mm and there was a significant decrease in efficiency whereby removal rate decreased with increasing number of pulses.

A.5 Examples Using Alumina Al₂O₃

Alumina ceramic specimens were made by Cold Isostatic Pressing (CIPing) of alumina powder, using a pressure of 376 MPa for a time of 2 minutes, plus the time to raise and lower the pressure.

FIG. 13 shows an SEM micrograph of the CIPed alumina powder showing the irregular shape of the particles with a typical size of less than 10 μm. It can be seen that the particles are not plate-like as were the steatite ones, meaning the packing is less dense and there is higher porosity.

Some of the CIPed alumina specimens were left dry for comparative laser ablation testing as described later. The remaining alumina specimens were partially submerged in a beaker of water so that the water came up to a level ¼ of the height of the specimen. The block was left for 24 hours to allow water to absorb into the block, and the mass was measured after 10 minutes and after 24 hours. The measured mass was compared with the theoretical maximum if all the pores were filled with water, and the water infiltration percentages calculated from the mass values. The porosity and water infiltration percentages are set out in Table 6 below.

TABLE 6
Porosity and Water infiltration Percentages for Alumina

| | |
|---|---|
| Measured density of block of partially CIPed alumina (kg/m³) | 1751 |
| Bulk density of steatite (kg/m³) | 3970 |
| Volume fraction of solid in block [(1257/2700) × 100)] | 44% |
| Volume fraction of pores in block | 56% |
| Percentage water infiltration after 10 minutes | 26% |
| Percentage water infiltration after 24 hours | 30% |

From the table it can be seen that despite its higher porosity when compared with steatite, alumina is less able to absorb water, even after 24 hours.

The water- soaked CIPed alumina specimens were then subjected to laser ablation using an Excimer laser having the parameters defined in Table 1 above. The dry CIPed alumina specimens were subjected to the same laser conditions as the water soaked specimens for comparison. The laser was set up with a fluence of 2.5 J/cm², this being in the range 1.5-3 J/cm² that had been shown to give good material removal on the titanium specimens. Both water-soaked and dry alumina specimens were subjected to a range of numbers of laser pulses ranging from 10 to 100 pulses.

It was observed that for the dry aluminium specimens, there was no effect from the laser pulsing even after 100 pulses. For the water-soaked specimens, there was noticeable removal even after 10 pulses. The maximum depth that could be removed was about 0.8 mm and there was a significant decrease in efficiency whereby removal rate decreased with increasing number of pulses. The specimen did dry out more quickly than had been the case with the titanium samples, which was probably due to the relatively low water absorption. For this reason, water was re-applied to the surface by a hand spray after every 10 pulses.

B. Examples Using Ethanol as the Volatile Liquid

Block specimens of partially sintered titanium powder (<45 μm CP Grade 2) sintered at 700° C. for 20 minutes were prepared. Four of the blocks were partially submerged in a beaker of ethanol so that the ethanol came up to a level ¼ of the height of the block, and left for 24 hours to allow the ethanol to absorb into the block, Four comparative block specimens (but also specimens falling within the scope of this invention) were partially submerged in a beaker of water so that the water came up to a level ¼ of the height of the specimen, and left for 24 hours to allow the water, to absorb into the block. An Excimer laser (with the properties defined hereinbefore in Table 1) was used at two fluences: 3.3 J/cm² and 5.1 J/cm². Eight experiments were done each consisting of 100 pulses of the laser on the specimen which had been presoaked in either ethanol or water for comparison at the different fluence levels. The depths of the resultant holes were measured to calculate the removal rate, and these removal rates (removal depth/pulse) are noted in Table 7 below and are also illustrated in the graph shown in FIG. 14.

TABLE 7

| Experiment | Volatile | | | Removal |
|---|---|---|---|---|
| No | Liquid | Laser frequency | Fluence | Depth μm |
| 1. | Ethanol | 10 Hz | 3.3 J/cm2 | 1.1 |
| 2. | Ethanol | 1 Hz | 3.3 J/cm2 | 0.5 |
| 3. | Ethanol | 10 Hz | 5.1 J/cm2 | 4.3 |
| 4. | Ethanol | 1 Hz | 5.1 J/cm2 | 4.8 |
| 5. | Water | 10 Hz | 3.3 J/cm2 | 2.1 |
| 6. | Water | 1 Hz | 3.3 J/cm2 | 2.3 |
| 7. | Water | 10 Hz | 5.1 J/cm2 | 3.0 |
| 8. | Water | 1 Hz | 5.1 J/cm2 | 4.6 |

From the data in Table 7 and FIG. 14 it can be seen that the effect of increasing fluence is greater for ethanol than for water. FIG. 15 is a graph showing the effect of change of fluence on removal rate on ablation (depth per pulse) for ethanol and water as the volatile liquid, on the titanium specimens. From this graph it can be seen that the threshold fluence for ethanol (about 1.2 J/cm²) is higher than that for water (about 0.9 J/cm²).

The effect of pulse frequency was studied since the two liquids could be expected to behave differently due to: a) their different volatility (meaning ethanol would evaporate away more quickly leaving the interaction site dry) and b) their different wetting properties (controlling how the liquid re-fills the pores near the interaction site having been evaporated by the previous pulse). At the lower fluence, the ethanol results show that the lower frequency gives less removal (0.5 μm/pulse at 1 Hz compared with 1.1 μm/pulse 10 Hz). It is thought that this difference is attributable to the fact that at the lower frequency of 1 Hz the total time to deliver the pulses (100 seconds) is longer, allowing the part time to dry out. At the higher fluence, the ethanol results seem independent of frequency (4.3 compared with 4.8 μm/pulse for 10 and 1 Hz respectively), whereas the water-soaked specimens exhibit a greater dependence on frequency (3 compared with 4.6 μm/pulse). It is thought that this is because the ethanol re-fills the pores more quickly than the water does.

FIGS. 16a and 16b show the capabilities of the methods according to the present invention, and are a photograph and cross-sectional micrograph respectively. They show a grid- like array of holes 21 made using the method according to the invention on titanium specimens. The holes 21 are up to 15 mm deep, with an aspect ratio of 10. They have a limited taper, for example 3-6° for a 2 mm deep hole. The ablated samples show only a small heat affected zone

To summarise, the present invention provides an improved laser ablation technique for making shaped parts, which starts from a powder route. The technique is carried out on only partially consolidated, still porous, shaped parts where the individual powder particles are only lightly bonded together. Moreover, the powder pre-cursor shape is infiltrated with a suitable volatile liquid such that the liquid is present throughout the material. Conveniently, the part may be pre-soaked in the liquid, before being removed and clamped in position on a computer controlled stage. Water and ethanol have been found effective for this purpose. A scanning laser beam is then applied to the surface of the material resulting in rapid heating of the liquid. The rapidly expanding vapour breaks the bonds between the powder particles and either ejects the powder from the part or facilitates the removal of the powder by another means. In this way, a scanning laser beam can be used to follow a CAD model and produce an accurate powder shape. The powder shape is then further consolidated e.g. sintered, at high temperature, to give a high density near net shape and, if required, can be still further treated, e.g. hot isostatically pressed to achieve full density. Using water, ethanol, or any other volatile liquid, to provide a high pressure vapour reduces the power and therefore the temperature required to cause ablation. Keeping the temperature lower avoids or minimises damaging the powder, which for several materials, e.g. titanium alloy would occur if water or other volatile liquids were not used. In addition to allowing the use of lower laser powers than current laser milling processes, the present laser ablation process is faster than current additive laser milling processes. Moreover, thin walls and delicate structures have been demonstrated which are possible as the process is non-contact and deep high aspect ratio holes can be produced which are difficult to produce by mechanical rapid manufacture techniques.

The present invention further provides any novel feature or any novel combination of features hereinbefore described that a skilled reader would understand could be selected in combination.

1. A method of manufacturing a shaped part, the method comprising:
(I) providing a partially consolidated, porous part that has been made from a powder;
(II) permeating the porous part with a volatile liquid, so that the liquid is present in the pores of the porous part; and
(III) forming the shaped part by applying a laser beam to a spot on the surface of the liquid-permeated part to cause the volatile liquid to heat in the spot region, causing the powder particles to separate in the spot region, so that a portion of the part is ablated in the spot region.

2. A method according to claim 1, further comprising the step of partially consolidating a powder to make the porous part provided in step (I) of the method.

3. A method according to claim 1, further comprising the step of strengthening the laser-ablated part.

4. A method according to claim 1, wherein the powder comprises a metallic or ceramic material.

5. A method according to claim 1, wherein the formed shaped part is close to or at its desired final shape.

6. A method of manufacturing a shaped metallic or ceramic part, the method comprising:
(I) partially consolidating a powder of a metallic or ceramic material to make a porous green part;
(II) permeating the green part with a volatile liquid, so that the liquid is present in the pores of the porous green part;
(III) scanning a laser beam over a spot on the surface of the liquid-permeated green part to cause the volatile liquid to heat in the spot region, causing the partially consolidated powder particles to separate in the spot region, so that a portion of the part is ablated in the spot region; and
(IV) further strengthening the green part to form the shaped metallic or ceramic part.

7. A method according to claim 1, wherein the powder is a metallic material, an alloy, an intermetallic compound, a ceramic material or a cermet material.

8. A method according to claim 1, wherein the volatile liquid is water or ethanol.

9. (canceled)

10. A method according to claim 1, wherein the volume fraction of the porous part that is occupied by the pores is in the range 0.05 to 0.6.

11. A method according to claim 1, wherein in the step comprising applying a laser beam, the laser wavelength is selected to be one having an absorption length in the volatile liquid of between 1 mm and 1 m.

12. A method according to claim 1, wherein the fluence of the laser is in the range 0.5-10 J/cm².

13. A method according to claim 1, wherein the laser spot size is at least 1.5 times, or even at least twice the average powder particle size.

14. A method according to claim 1, wherein the powder used comprises titanium powder, a titanium alloy powder, or aluminium powder, or steatite powder, or alumina powder.

15. A method according to claim 1, wherein the powder used consists essentially of substantially spherical particles.

16. A method according to claim 1, wherein the powder used comprises substantially irregular shaped particles.

17. A method according to claim 1 wherein the average particle size of the powder is in the range 1 nm to 1 mm.

18. A method according to claim 1 wherein the laser used is an excimer laser.

19. A method according to claim 1 wherein the laser used has a wavelength in the range 180-310 nm or 700-1200 nm.

20. A method according to claim 1 wherein the laser is programmed to follow a two dimensional or three-dimensional computer aided design.

21. A method according to claim 1 which is used for laser drilling, surface texturing, laser cleaning, mining, stone cutting, sculpting, decorative art production, demolition, or dismantling.

22. (canceled)

23. (canceled)

24. (canceled)
